(19) United States
(12) Patent Application Publication
(10) Pub. No.: US 2019/0180378 A1
(43) Pub. Date: Jun. 13, 2019

(54) ENGINE, SYSTEM AND METHOD OF PROVIDING REAL-TIME INSURANCE COVERAGE AND PRICING MODIFICATIONS BASED ON CLOUD-BASED BUSINESS VALUATION

(71) Applicant: Michael M. Carter, Wayne, PA (US)

(72) Inventor: Michael M. Carter, Wayne, PA (US)

(21) Appl. No.: 16/155,335

(22) Filed: Oct. 9, 2018

Related U.S. Application Data
(63) Continuation-in-part of application No. 16/034,628, filed on Jul. 13, 2018.
(60) Provisional application No. 62/532,094, filed on Jul. 13, 2017.

(51) Int. Cl. G06Q 40/08; G06Q 10/06; H04L 29/08

(52) U.S. Cl. CPC G06Q 40/08; H04L 67/12; G06Q 10/067

(57) ABSTRACT

An apparatus, system and method of dynamic insurance coverage in accordance with a cloud-based business valuation. The apparatus, system and method may include monitoring the business value substantially continuously; communicatively connecting an output of said monitoring to a remote input of an insurance system; assessing, by the insurance system based in part on the business valuation, of an under-writeable band of at least insurance needs; offering insurance at a discount from the under-writeable band; automatically adjusting the insurance and underlying premium pricing based upon variations in at least the business value up to the under-writeable band; and substantially continuously performing the automatically adjusting.

### CROSS REFERENCE TO RELATED APPLICATIONS

This application is a continuation-in-part of U.S. patent application Ser. No. 16/034,628, filed Jul. 13, 2018, which claims priority to U.S. Patent Application No. 62/532,094, filed Jul. 13, 2017, which are hereby incorporated by reference in their entireties.

### FIELD OF THE INVENTION

The present invention relates to the financial aspects associated with an insurance, and, more particularly, to an engine, system and method of providing real-time insurance modifications based on cloud-based business valuation.

### BACKGROUND OF THE INVENTION

There are over 30 million small businesses in the U.S. and over 200 million small businesses globally. These small businesses may be severely limited by a lack of knowledge regarding their respective businesses, the assets thereof, and the effect of those values on the value of the assets of the proprietors thereof. This limitation on small businesses may create a ripple effect that affects other businesses. For example, Insurance agents or advisors, and/or the insurance carrier that services them, may have difficulty properly calculating and monitoring the insurance needs of business owner clients or prospects without fully knowing the value of the actual business owned.

Thus, there exists a need for an engine, system and method that provides real-time/timely assessments, including requisite modifications, such as pricing and coverage changes, to insurance, based on cloud-based business valuation.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention;

FIG. 4 illustrates an aspect of an exemplary embodiment of the present invention;

FIG. 5 illustrates an aspect of an exemplary embodiment of the present invention;

FIG. 6 illustrates an aspect of an exemplary embodiment of the present invention;

FIG. 7 illustrates an aspect of an exemplary embodiment of the present invention; and

FIG. 8 illustrates an aspect of an exemplary embodiment of the present invention.

### DETAILED DESCRIPTION

Computer-implemented platforms, engines, systems and methods of use are disclosed that provide networked access to a plurality of types of digital content, including but not limited to video, audio, metadata, interactive and document content, and that track, deliver manipulate, transform and report the accessed content. Described embodiments of these platforms, engines, systems and methods are intended to be exemplary and not limiting. As such, it is contemplated that the herein described systems and method can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

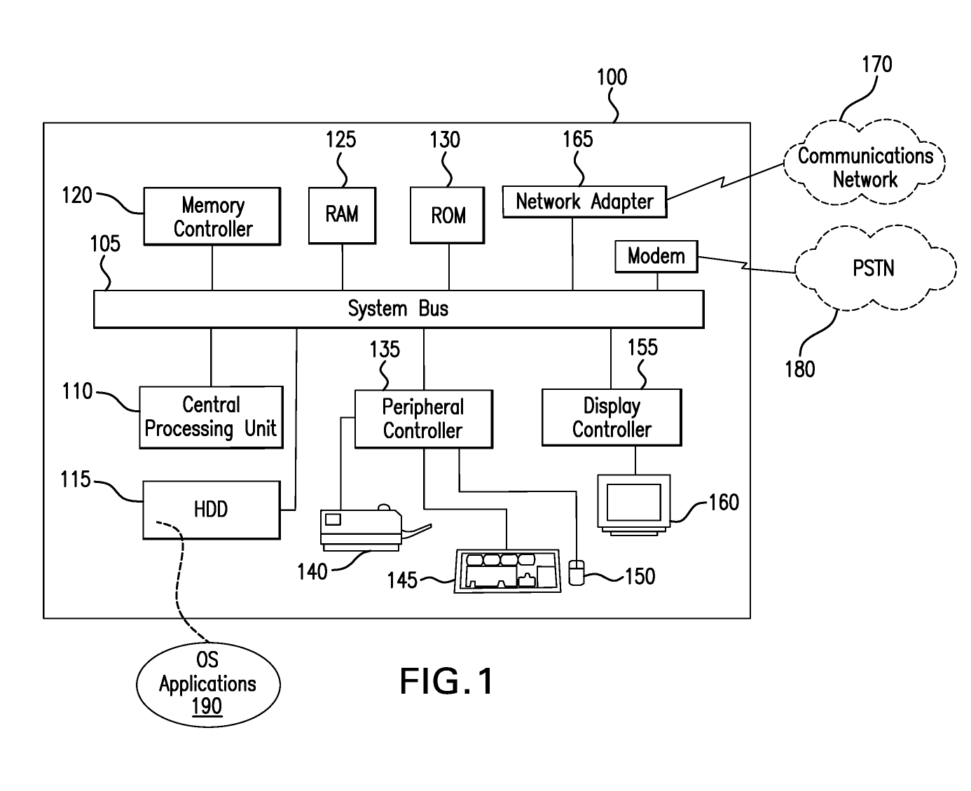

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HOD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

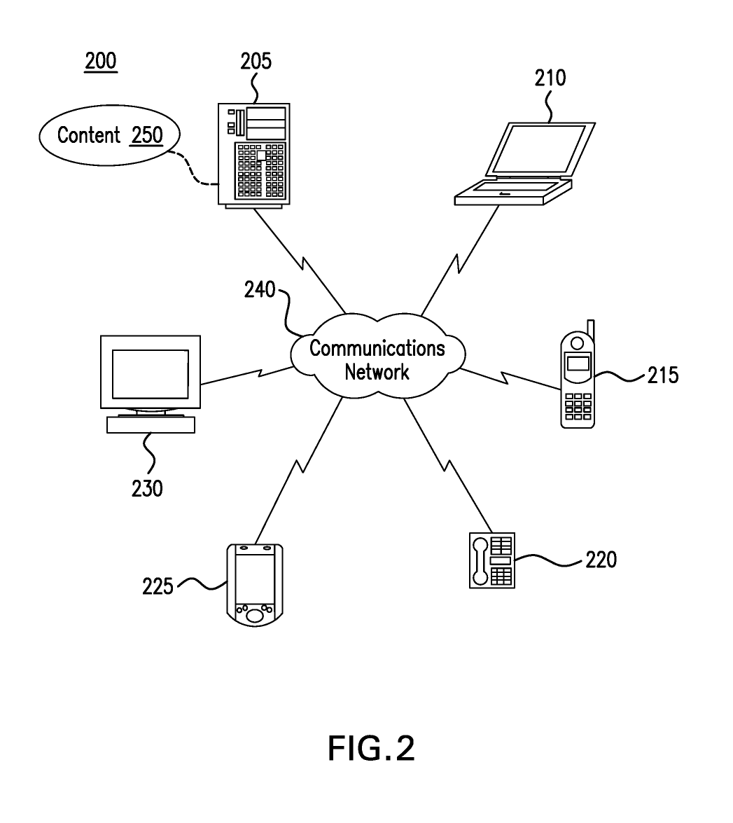

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

The present invention may include a thin client service that provides services modification, such as to insurance levels, as may be dictated by cloud-based business valuations and associated services. The present invention may preferably provide a simple process with a limited number of interactive steps. The steps are designed to use basic, yet key factors known or readily available to the requesting user, as input to the rules engine of the present invention.

In a preferred embodiment, an electronic and/or written report may be provided as output from the engine, and responsive to the inputs to the engine, such as to update one or more types of insurance associated with a business, or with the proprietor(s) thereof. Such a report may be provided and/or communicated via thin client, thick client, mobile app, application, dynamic monitor, installed applet, widget, or the like, and may be provided as software as a service (SaaS), by way of non-limiting example, using the computing system embodiments discussed above.

The present invention may focus on small to midsize businesses for the valuation and associated services discussed herein, as such an area has the greatest need for the services provided by the present invention. However, the present invention may additionally have applicability for all parties in a transactional flow, such as larger businesses, and such as those offering loans, grants, and services, such as insurance, accounting or legal services. As such, all parties in a business-related transactional flow may benefit from the convenience, speed, accuracy, validity, and low cost of valuations and associated services provided by the rules engine of the present invention responsive to the requesting user and/or third-party information inputs.

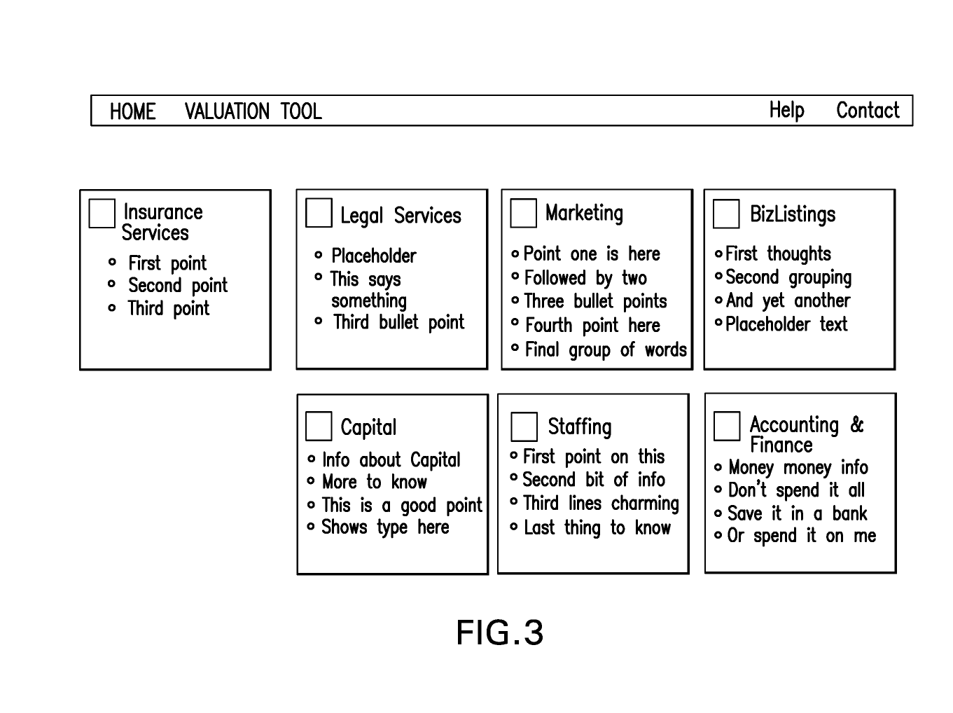

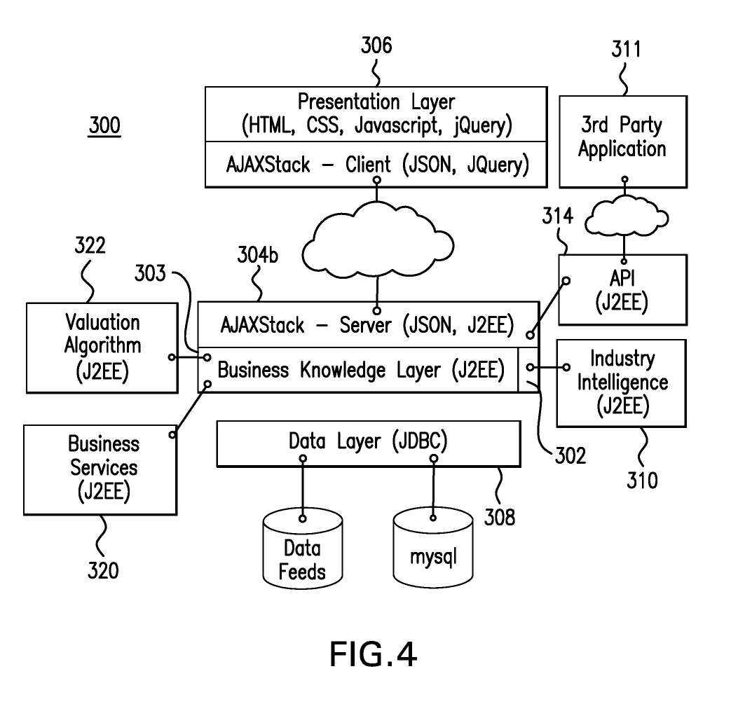

By way of non-limiting example, FIG. 3 illustrates a number of tools/apps that may be thus provided. Such tools may include, for example, legal or accounting services, marketing assistance, capital management, staffing or payroll management, and/or accounting and finance. An engine, system and method discussed herein throughout may be provided, by way of non-limiting example, by the exemplary system 300 infrastructure illustrated in FIG. 4. In the illustrated embodiment, the system 300 may include an engine 302 for performing the aspects discussed herein, shown as resident in the business knowledge layer 303. The engine 302 may be comprised of computing software that executes a set of rules that function to generate the aspects discussed herein, and hardware necessary to execute such computing functions as discussed above with respect to FIGS. 1 and 2.

Engine 302 may, for example, gather inputs from various sources, most preferably including at least the inputs received from the requesting user responsive to the aforementioned steps discussed herein throughout, to thereby transform the inputs into valuations and then to associated services, such as insurance policies and/or modifications, as discussed.

The engine 302 may be, in a preferred embodiment, a rules engine embedded in the business knowledge layer 303. Typically, a rules engine 302 is defined to include a software component that readily allows for the addition of or changes to business logic in a process management system. A business rule is a computing statement that uses business logic to describe a policy, procedure or calculation. Business logic describes the sequence of operations that may be associated with data in a database to carry out the applicable business rule.

A rules engine generally separates execution code for the rules from the rest of process management. Thus, when a change is made to a rule or rules, the rules engine may evaluate the change's effect on other rules and flag any conflict without affecting the remainder of the processes. A rules engine may include a rule repository, such as a database, for storing the rules, a rule editor, such as a user interface, that allows users to define, design, document and edit the rules, a reporting component that allows users to query and report existing rules, and a rules engine execution core, which is comprised of the programming code that enforces the rules.

Function calls for engine 302 may be made to the AJAX stack 304a, b, which may be provided server side for local engine 302 calls and client side for remote calls, as illustrated. Client side presentation may be made via the presentation layer 306, as illustrated, and client side information may be requested and received thereby. The data layer 308 may receive various data feeds, and may store additional data, wherein such data may be received from the network, such as from the Internet cloud. Such data may be gained, for example, via directed search, spider or crawl search, data streaming, or the like. Such data may include, by way of non-limiting example, third party reporting (such as Dunn & Bradstreet, by way of non-limiting example), searching for positive or negative references to the entity being valuated, industry specific information, intellectual property information, taxation or public financial information, or the like.

Data in data layer 308 may additionally include, for example, a repository of educational information for requesting users, such as information regarding taking on investment for requesting users that indicate the requested valuation is made because investment is sought. For example, electronic guides may thus be provided and stored as system data, such as guides regarding buying and selling businesses, obtaining loans, grants, and investment, writing a business plan or investor presentation, or the like.

Likewise, industry intelligence may be accumulated at block 310. Such industry intelligence may be gained via the cloud, and additionally may be gained by the engine 302 based on the repeated running of valuations by engine 302. Industry intelligence may include monitoring of a website provided via the presentation layer 306. Such monitoring may include, for example, traffic monitoring, user feedback, and the like, and may additionally include, such as via the third party application interface 311 reached from engine 302, the use of third party monitoring, such as Google Analytics, Kampyle, Bizo, Clicktale, and the like. Industry intelligence may be accumulated by, for example, industry sector or customer type (i.e., licensee, individual, etc.).

Information may be provided to the API 314, for ultimate use by engine 302, by any of a variety of feeds, such as via the cloud. Therefore, information may be gained from a third party, such as via a search or the like. Information may further pass, for example, from third party applications (such as may be provided by credit agencies, Dunn & Bradstreet, governmental agencies, or the like) through the API 314 to the engine 302.

Key elements provided by engine 302 in the business knowledge layer may include the services 320 provided via application of the valuation criteria 322. The services 320 may include, for example, valuation based on the criteria 322 as applied to the information provided via the data layer 308, via third party applications and API 314, via industry intelligence 310 and via client side 306, and/or secondary services in accordance with the valuation, such as modifications to insurance services as the valuation updates. That is, services 320 may include recommended insurance and/or inadequacies in insurance, such as may be calculated pursuant to criteria 322 based on at least entered and/or calculated data, such as the valuation service as referenced above.

In an exemplary embodiment, the valuation and the services corresponded thereto, such as the insurance services, may periodically update along with the valuation, and/or substantially continuously receive a modification responsive to, for example, a change in the valuation. By way of non-limiting example, a significant paradigm shift, such as the recent proliferation of tablet computers, might cause all parties that had requested valuations and that fall in verticals associated with tablet computers to receive a modification to business insurance policies based on the changes in the business's valuation.

The valuation value may be calculated using known methods available online, such as through a dedicated online engine. By way of example, an SOE may be multiplied by a selected industry multiplier, and may have applied thereto a series of industry-specific adjustment factors which may, for example, again be obtained external to system 200 by engine 202:

valuation=SOE×multiplier:

adjustments may include, for example:
1. Negative valuation adjustment;
2. Adjust to recurring revenue:
   If percent0f8usinessRecurring is 80% or more, add A% to valuation.
   If it is between 80% and 50%, add 8%.
   If it is between 50% and 40%, add C%.
3. Adjust to intellectual property:
   If more than 5 patents, add 8%
   If 2 to 5, add C%
   If 1, add 0%
   If there are no patents, subtract 0%
4. Adjust to percent of sales from top three customers:
   If 0 to 25%, no adjustment,
   If 25% to 70%, subtract C%.
   If 75% to 100%, subtract 8%.
5. Adjust to the “if the owner left” impact:
   If remain the same, no adjustment,
   If decline minimally, subtract ˜0%
   If decline moderately, subtract C%
   If decline substantially, subtract 8%
   If plummet, subtract A%
6. If the valuation is negative at this point, it may be reset to 0, or alternative calculation methodologies may be employed by engine 202.
7. Subtract debt for recent year only. Add cash for recent year only.
8. Subtract 50% of depreciation for recent year only.
9. Add fixed Assets for recent year only.
10. Add 80% of accounts receivable for recent year only.
11. Add 75% of inventory for recent year only.

Of course, those skilled in the pertinent arts will appreciate that other calculation means, or adjustments, may be employed by engine 302, and further that certain calculations performed by engine 302 may constitute reportable, standalone calculations that may be output in a report by engine 302. Further, the presentation layer, AJAX, business knowledge layer, and/or data layer, such as discussed with respect to FIG. 4 may be, by way of non-limiting example, java based (such as javascript, J2EE, JSON, jquery and JDBC). Database(s) of the present invention may be, for example, mysql, and searching may be performed, by way of non-limiting example, via Solr. Additionally, presentation may be made via the presentation layer 306 using html, xml, and CSS, among many others that will be apparent to those skilled in the pertinent arts.

Moreover, the presentation layer may provide the access to engine 302 as, for example, a widget. As used herein, a widget is a stand-alone application comprising embeddable “chunks” of code that can be embedded into third party sites by a user, such as onto a webpage, blog, or profile on a social media site. A widget according to the present invention provides a dynamic web app that may be shared across any websites to which the code chunks may be installed and embedded. Installation may occur, for example, by copying and pasting the embedded code, or widget, into the desired page. Simplistic widget functions may include link counters and advertising banners, and in the present invention may include, for example, providing of the scoring discussed herein pursuant to entry of only limited information by the requesting user. Needless to say, this widget may drive traffic to a base website associated with engine 302, and may additionally create significant value, and drive traffic, for any third party site onto which this widget is placed. The present widget is a downloadable application that looks and acts as a traditional app, but that that is implemented using web technologies such as JavaScript, Flash, HTML and CSS, for example.

Query steps associated for valuation and/or secondary services may include queries related to general company/profile information, financial information (such as income, assets and growth factors), and operations/personnel information. These query steps may be broken down further into additional query steps. Such additional information may vary in accordance with an industry of the requesting user, a type of insurance requested, or the like. Other factors may be optionally added to query steps, or may be weighted if entered at the option of the requesting user. Such other factors may include, for example, third party information and/or publicly available information (such as public relations information).

Use of the present invention enables insurance firms to provide real-time reporting, recommended or executed modifications (including premium updates, and/or scoring for small businesses and small business owner clients. Similarly, the use of the present invention by insurance firms may have applicability for buy-sell agreements with business partners, and/or for estate planning, for example. The present invention may be offered, in an embodiment such as this, in a secure manner, such as via intranet or behind a firewall, solely for use by licensed agents and/or account managers.

Yet more particularly, the present invention may provide a real-time charging system for insurance premiums. In a particular example, insurance agents offer, for example, term life and whole life policies, but the adequacy of the coverage of such policies, for a small business owner, is highly related to the value of that small business owner's business. Thus, the present invention allows the small business owner to be provided with a highly valid indication of business valuation, and, if the received business valuation indicates that the insurance coverage for the owner of that business is not adequate, an adequate policy and/or coverage may be optionally or non-optionally put to the small business owner.

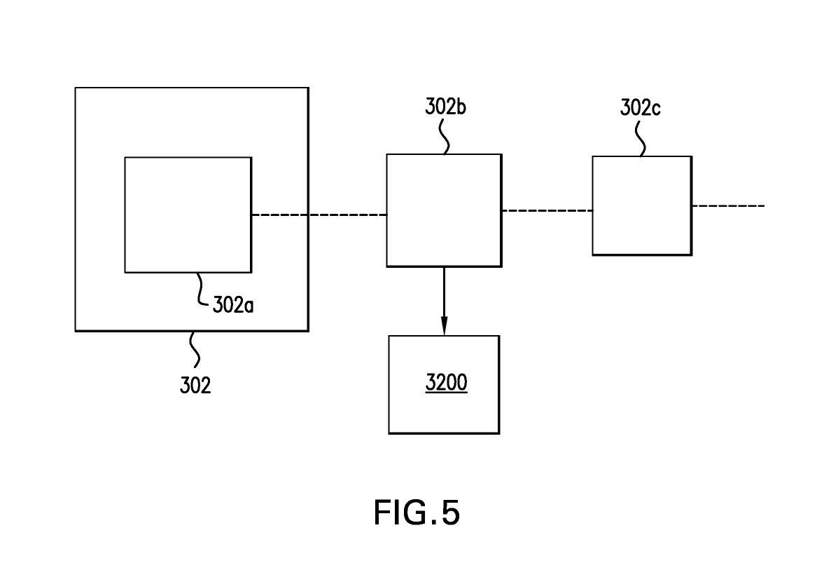

As discussed throughout, the disclosed systems and methods allow for real-time adjustment of secondary and tertiary data as that secondary and tertiary data relates to the generated business valuation. This contribution to secondary and tertiary data generation by the generated business valuation may occur within the disclosed platform, such as via engine 302 and the rules provided therein, or may occur across multiple different platforms using distinct engines 302a, 302b, 302c . . . , which may be partially interconnected, such as to allow for the exchange of necessary information to allow each engine 302 to perform its function, but wherein such information may be “push only”, such as to prevent access by any one distributed engine to non-needed information on another connected engine. This is illustrated in the example of FIG. 5.

That is, a generated business value may be automatically or manually fed to an input of an additional algorithm or algorithms within an engine 302, or distributed between engines 302a, 302b, 302c . . . , within the disclosed platform or across platforms, and distinct data seemingly unrelated to business valuation may be generated therefrom. Thus, the business valuation generated may be output from the engine 302a of the disclosed platform to a distinct independent platform engine 302b. This distinct engine 302b (or engines) may comprise an application, app, applet, widget, dynamic monitor, server, or the like, and each distinct independent platform engine may include one or more algorithms that automatically or manually employ the generated a business valuation to calculate secondary or tertiary data, such as insurance data, based thereon that is seemingly unrelated thereto.

By way of nonlimiting example, the disclosed business valuation platform 302b may provide a system and method of generating the aforementioned dynamic insurance policy output 3200. The policy may be, by way of example, business, life, buy/sell, casualty/property, key person, general liability, cyber, and/or other insurances. For example, such a policy may automatically adjust the value of life insurance for a proprietor or officer of a company as the valuation of that company also adjusts. This generation of a modified life insurance value may occur within the disclosed platform, or the business valuation may be continuously, periodically, or manually fed to an independent platform including algorithms for generating life insurance value based on the value of a business for which the life insured is an owner.

Yet further, as the business valuation adjusts, the coverage needs of the life insured may also adjust in accordance with known algorithms. This information may then further cascade, such as to engine 302c, which may apply banking data, such as a withdrawal, in accordance with an adjusted premium calculated by engine 302b based on the valuation calculated at engine 302a. It goes without saying that amounts due, paid, policy pricing, policy adjustments, and the like may be securely and independently monitored and tracked as between the aspects discussed herein, such as by blockchaining by way of non-limiting example.

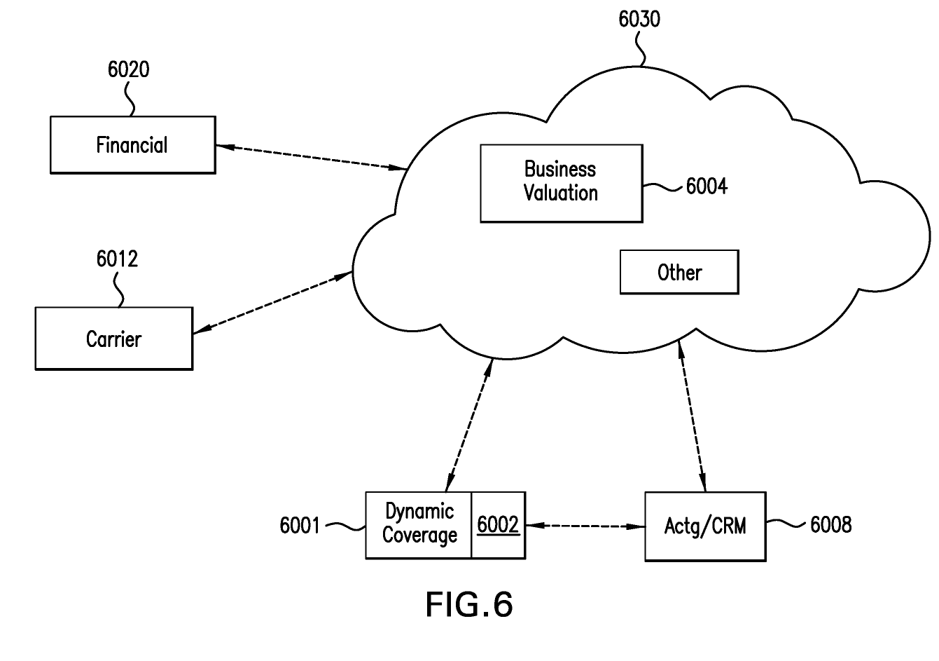

More particularly, FIG. 6 illustrates a schematic diagram of a system according to the embodiments. As illustrated, the real time policy engine 6001 may assess dynamic policy coverage, and calculate consequent insurance premiums, using business rules 6002. These business rules may apply algorithms to cloud based information, such as may be generated by cloud-based dynamic business valuation engine 6004.

Both the business valuation engine 6004 and the policy engine 6001 may be in communication with and/or be accessible to accounting/CRM system 6008. The accounting/CRM system may be, by way of example, Intuit, Xero, SalesForce, or the like, and may calculate data to inform the processes performed by dynamic policy engine 6001.

The policy engine 6001 may, in turn, be communicatively connected to both a carrier illustration and policy issuance system 6012, and a dynamic financial and payment monitoring system 6020. The policy illustration and issuance system 6012 may receive the information generated by policy engine 6001, and may therefrom issue and/or illustratively provide or display, to an insured or an agent, for example, the dynamic policy and pricing generated by engine 6001 based on the data is received. The financial and payment system 6020 may interconnect to, for example, a financial institution, such as in order to obtain payments with the periodicity agreed to in the issued policy stemming from engine 6012 and as indicated by the by the rules applied by engine 6001.

Of note, any one or more of the foregoing systems and methods may reside in, and/or communicate through, the cloud 6030. That is, any one or more of the data points, rules engine, engines, systems or methods may be local to or remote from the others referenced in FIG. 6 without departing from the spirit or scope of the invention.

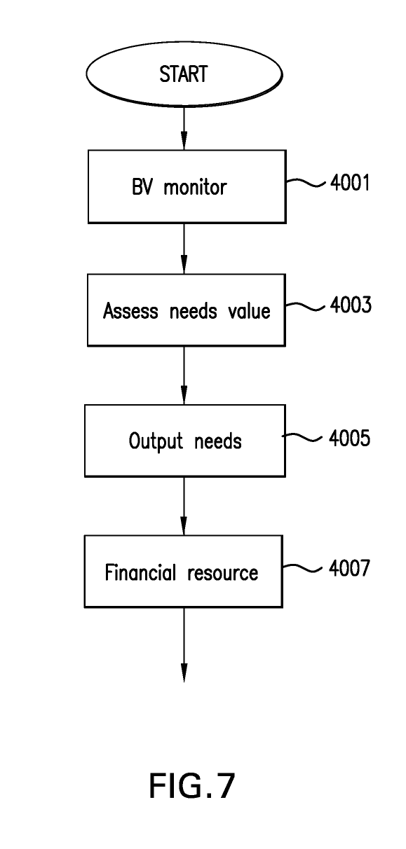

Therefore, and by way of nonlimiting example, FIG. 7 illustrates a method of dynamic life generating life insurance in accordance with the business valuation. As shown and at step 4001, a business value monitoring service may be set up as discussed herein throughout. At step 4003, the business value monitoring service may connect to one or more in platform algorithms, or to an external accounting or financial system, to allow for the application of insurance coverage needs and/or value, such as life insurance value that would be recommended for a proprietor of the continuously changing business valuation of the business monitored at step 4001. By way of nonlimiting example, the business valuation monitoring system may connect to the XERO system, to intuit, to sales force, and/or to a proprietary insurance algorithm application.

At step 4005, a life insurance policy value and/or coverage needs may be output in accordance with the calculated secondary data assessed at step 4003. Step 4005 may be performed periodically, continuously, or upon manual, direction, and the timing of the repetition of step 4005 may or may not be tied to the timing of the generation of primary data at step 4003.

An optional step 4007, the output of step 4005 may or may not be linked to the financial resources of the proprietor. Accordingly, if the output of step 4005 is linked to the financial resources of the proprietor for whom life insurance needs and/or value has been assessed, the dynamic policy of the proprietor may allow for real-time insurance premium adjustment and automatic debit from the proprietor's financial resources. This debiting may, needless to say, be pretty authorized by the proprietor, and may occur only upon certain time frames, such as monthly, or may occur as a continuous adjustment over a given window, such as a 30 day period.

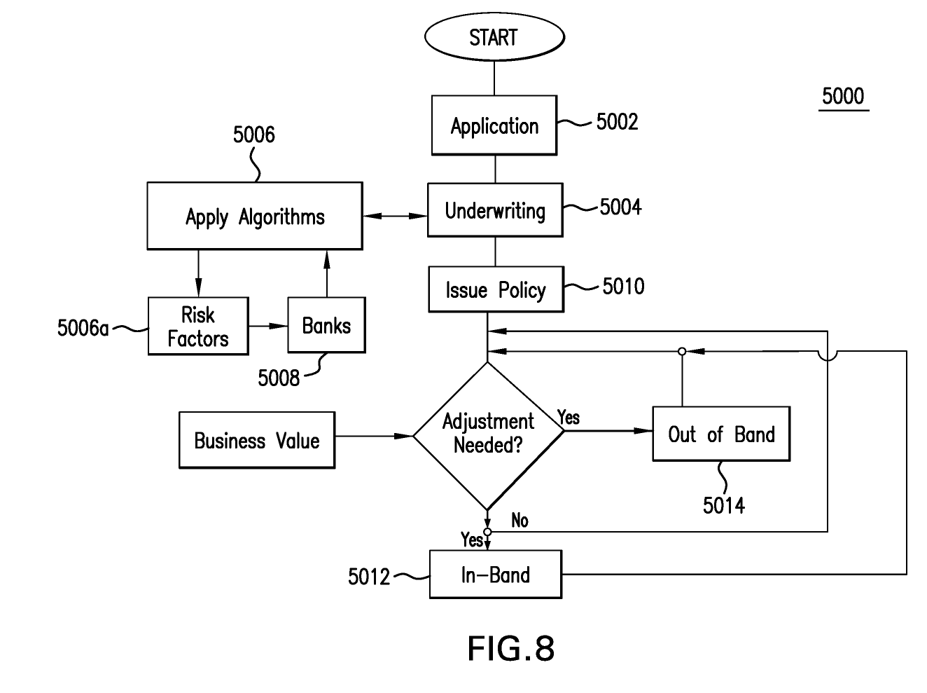

Moreover, and as illustrated in the flow of FIG. 8 and in accordance with the discussion above, the embodiments may provide a method of performing a bounded, real time, dynamic insurance policy update 5000. As referenced above, insurance maybe algorithmically related to dynamic changes in the business value owned by the policyholder/applicant, related to the owner's share in the business, and/or related to other similar aspects of the business owner's business. Thereby, and in addition to the dynamic changes discussed above, real time insurance may allow for modifications to the insurance needs of the business owner in real time.

As illustrated, upon initial application 5002, the underwriting of the policy for the business owner may be performed in ranges at step 5004. For example, after receipt of the application underwriting of a life insurance policy may indicate that the business owner be most appropriately placed in an approved range of $3,000,000-$5,000,000. However, based on policy issuance algorithms applied at step 5006, such as may be indicated by bands related to certain risk factors 5006a, such as vertical industry in which the business operates, hard business assets, number of business partners, and the like, a band may be selected 5008 into which the policy applicant is placed, and the policy issued 5010 accordingly. The band selected at step 5008 may indicate, for example, the percentage of, or the percentage discount from, the full underwriting value that should be made available to the policy applicant from step 5002 based on the algorithms applied at step 5006.

By way of example, an underwriter may approve an applicant for $6,000,000 of life insurance, and the applicant maybe placed in a 33% band. Accordingly, the offer made to the policy applicant maybe approximately ⅓ less than the full available value, i.e., $4,000,000 in coverage. Thereby provided is a pre-approved, previously underwritten dynamic range in which the policy value available to the applicant may move at a later time, such as based on the dynamic changes discussed throughout the disclosure.

As will be appreciated by the skilled artisan in light of the discussion herein, bands may vary from 10% to 95% of a discount from the full available value, by way of example. Bands maybe based on static or dynamic factors, such as based on changes in the business, the industry in which the business operates, the base value of the initial policy, or other factors, as discussed above. An upward (or downward) adjustment in-band may occur at step 5012.

Moreover, if the dynamic needs of the policyholder indicate that a real time policy update requires a new policy issuance in excess of the initially underwritten value, i.e., the dynamic changes indicate an upward policy need that is out of band, the dynamic insurance engine discussed herein may call for a manual or automated update at step 5014. For example, an automated alert may be sent to one or more agents that a coverage health check is necessary for the policyholder based on dynamic changes in, for example, the valuation of the policyholder's business. Such alerts maybe sent in real time, such as via email, text, phone, or the like.

A fully automated out-of-band alert at step 5014 may access available computerized underwriting assessments, such as may allow out-of-band variations depended upon any number of factors. For example, all policyholders may have accessible thereto a 5% premium over the initial underwritten amount, or different bands of excess amounts maybe available based on any number of factors, such as those risk factors discussed herein.

In accordance with the foregoing method, life insurance, or similar financial instruments, for an entrepreneur, as well as business insurance coverage, may be adjusted or based upon the value of a business enterprise. This adjustment may occur in real-time, such as dependent on a constant monitoring of the business valuation, such as either continuously, in a predetermined time frame (i.e., daily, weekly, etc.), or upon manual direction. Further, the adjustments to life insurance, business insurance, or the like may or may not occur in accordance with the timing of the reassessment of the business valuation in the disclosed embodiments.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A method of dynamic insurance coverage in accordance with a cloud-based business valuation, comprising:
monitoring the business value substantially continuously;
communicatively connecting an output of said monitoring to a remote input of an insurance system;
assessing, by the insurance system based in part on the business valuation, of an under-writeable band of at least insurance needs;
offering insurance at a discount from the under-writeable band;
automatically adjusting the insurance and underlying premium pricing based upon variations in at least the business value up to the under-writeable band; and
substantially continuously performing the automatically adjusting.
